(19) United States
(12) Patent Application Publication
(10) Pub. No.: US 2008/0102219 A1
(43) Pub. Date: May 1, 2008

(54) Thin Metal Film System To Include Flexible Substrate and Method of Making Same

(75) Inventors: Donald Laurence Thomsen, Yorktown, VA (US); Robert George Bryant, Lightfoot, VA (US)

Correspondence Address: NATIONAL AERONAUTICS AND SPACE ADMINISTRATION;LANGLEY RESEARCH CENTER, MAIL STOP 141, HAMPTON, VA, 23681-2199, US

(73) Assignees: United States of America as represented by the Administrator of the National; Aeronautics and Space Administration, Washington, DC (US)

(21) Appl. No.: 11/941,262

(22) Filed: Nov. 16, 2007

Related U.S. Application Data
(62) Division of application No. 11/279,009, filed on Apr. 7, 2006.

(51) Int. Cl. B05D 1/36; C25D 5/00

(52) U.S. Cl. 427/404; 205/80

(57) ABSTRACT

A flexible thin metal film system is made by directly depositing an electrically-conductive metal onto the metal surface of a self-metallized polymeric film.

### ORIGIN OF THE INVENTION

The invention was made by employees of the United States Government and may be manufactured and used by or for the Government of the United States of America for governmental purposes without the payment of any royalties thereon or therefor. This application is a divisional application of commonly-owned patent application Ser. No. 11/279,009, filed Apr. 7, 2006.

### BACKGROUND OF THE INVENTION

1. Field of the Invention

This invention relates to thin metal films. More specifically, the invention is a thin metal film on a flexible substrate and method of making same where the resulting thin metal film has increased conductivity.

2. Description of the Related Art

Thin metal films that are thinner than or equal to the mean free path of the electron for the given metal do not exhibit conductivity equivalent to or even close to that of the metal in bulk form. This is because these very thin metal films exhibit scattering of electrons when a current is passed therethrough and, therefore, have a higher volume resistivity when compared to the bulk form of the material. This situation is exacerbated when there are impurities in the metal. Thus, there is a need to make a thin metal film having adequate conductivity for its intended purpose.

In addition to making a thin film adequately conductive, many applications would also benefit from a thin metal film that is flexible. This is currently achieved by providing a flexible polymer substrate, pre-treating the substrate, and then thermally evaporating or electroplating a thin metal film onto the pre-treated substrate. Polymer substrate pre-treatment is required since the thermal evaporation of metals onto polymer films and the electroplating of metals onto polymer films suffer from adhesion problems. The goal of polymer pre-treatment is to create a surface to which the metal films will adhere so that the metal film does not flake off the polymer surface.

Typical pre-treatment methods use strike layers. For example, a chromium-chromium oxide surface layer is often used on polymer films as a strike layer before deposition of noble metals such as gold. Other polymer-surface pre-treatments (i.e., used prior to electroplating or electroless metal deposition onto a dielectric polymer film) include surface roughening and reacting the polymer surface with what are known as “strike solutions”. More specifically, steps for a typical plating cycle include surface cleaning, solvent treatment (to make the polymer wettable), conditioning (e.g., using chromic acid and sulfuric acid solutions or potassium dichromate and sulfuric acid solutions), and preparation of the catalytic surface. The preparation of the catalyst surface is sensitization, nucleation, and postnucleation. Generally, this is a one step process using stannous chloride and palladium(II) chloride. The palladium(II) is reduced by tin(II) to form colloidal palladium that is stabilized by tin(IV).

In summary, the polymer-surface pre-treatment processes increase the cost of thin metal films. Furthermore, the resulting thin metal film is generally defined by a thickness such that the metal film suffers from inadequate conductivity for many applications as described above.

### SUMMARY OF THE INVENTION

Accordingly, it is an object of the present invention to provide a method of making thin metal films having increased conductivity.

Another object of the present invention is to provide a flexible thin metal film.

Still another object of the present invention is to provide a simple method of making flexible thin metal film having increased conductivity.

Other objects and advantages of the present invention will become more obvious hereinafter in the specification and drawings.

In accordance with the present invention, a flexible thin metal film system includes a self-metallized polymeric film having a metal surface that defines a strike layer, and an electrically-conductive metal deposited directly onto the strike layer with no pre-treatment of the polymeric film being required.

### BRIEF DESCRIPTION OF THE DRAWINGS

FIG. 1 is a schematic view of a flexible thin metal film system in accordance with the present invention; and

FIG. 2 is a schematic view of an embodiment of an experimental setup used to fabricate a flexible thin metal film system in accordance with the present invention.

### DETAILED DESCRIPTION OF THE INVENTION

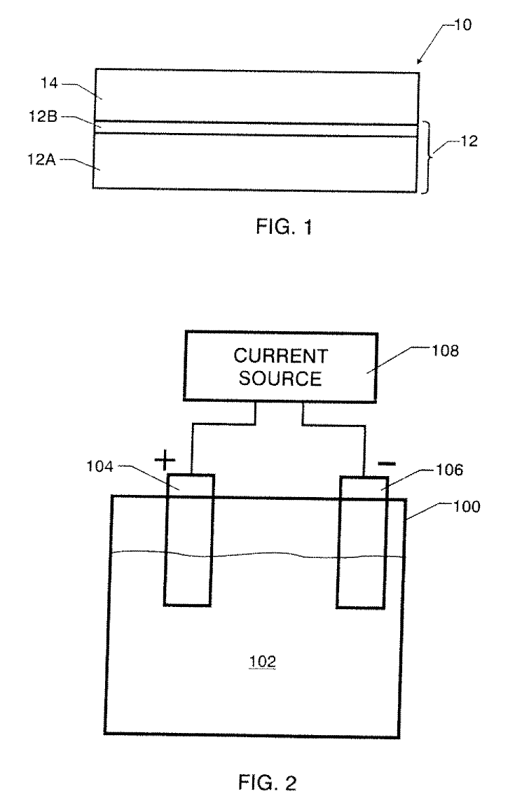

Referring now to the drawings, and more particularly to FIG. 1, a flexible thin metal film system is shown and is referenced generally by numeral 10. Flexible thin metal film system 10 and the methods presented herein for constructing system 10 can provide the basis for a wide variety of electronic circuits and/or devices, the choice of which is not a limitation of the present invention.

Thin metal film system 10 obtains its flexibility from a self-metallized polymeric film base 12 that, in general, has an underlying sheet 12A of polymeric material with a surface layer 12B that is a conductive metal. In general, the structure of self-metallized polymeric film 12 is created/developed in one or more processing stages. Conventional two-stage processing involves preparing/fabricating polymer sheet 12A and then depositing surface layer 12B onto sheet 12A. However, absent a pre-treatment process, there will be adhesion problems between sheet 12A and surface layer 12B as described earlier.

The adhesion between sheet 12A and surface layer 12B is greatly improved if self-metallized polymeric film 12 is created/developed by single-stage processing of a homogenous solution of a native metal precursor (as a positive valent metal complex) and a selected poly(amic acid) precursor of the final polymer. Single-stage thermal or light processing simultaneously causes the polymer to form while the metal atoms aggregate at the surface of the polymer in a very thin layer on the order of 500-2000 Angstroms (Å) in thickness. Such single-stage processing is disclosed by R. E. Southward et al., in “Inverse CVD: A Novel Synthetic Approach to Metallized Polymeric Films,” Advanced Materials, 1999, 11, No. 12, pp 1043-1047, the contents of which are hereby incorporated by reference. The resulting self-metallized polymeric film 12 is flexible and does not suffer from the afore-mentioned adhesion problems. However, the conductivity of metal surface layer 123 is limited by the thicknesses thereof that are achievable by the single-stage self-metallization process.

The present invention, in at least one embodiment, provides a thin metal film system 10 having an increased conductivity by depositing a layer 14 (or multiple layers) of an electrically conductive metal directly onto surface layer 12B. That is, metal layer 14 is deposited directly onto surface layer 12B without any adhesion pretreatment of layer 123. In other words, surface layer 12B serves as a strike layer for metal layer 14 that is deposited onto surface layer 12B by one of a variety of electrodeposition methods to include electroplating. However, it is to be understood that layer 14 could also be deposited directly onto surface layer 12B by means of a variety of electroless deposition/plating techniques without departing from the scope of the present invention. For a description of electroless plating techniques, see Chapter 17 of “Electroplating” by Frederick A. Lowenheim, McGraw-Hill Book Company, New York, 1978. Still other techniques for depositing metal layer 14 include, for example, immersion or displacement plating, chemical reduction deposition such as silvering, thermal evaporation, sputtering and chemical vapor deposition.

By way of illustration, one example of the present invention's thin metal film system fabrication will be described herein with the aid of FIG. 2. The exemplary fabrication process is a conventional electroplating process such as that described by E. Raub et al., in “Fundamentals of Metal Deposition,” Elsevier Publishing Co., Amsterdam, 1967. A clean container 100 is filled with a silver electroplating aqueous solution 102 composed of (i) AgCN (29 g/L Ag), (ii) KCN (37.5 g/L), and (iii) K₂CO₃ (60 g/L). A palladium self-metallized polyimide film 104 having a palladium surface layer (i.e., thickness of approximately 800 Å) serves as a cathode for the electroplating process. A silver foil 106 serves as the anode for the electroplating process. A current is applied to cathode 104/anode 106 by means of a current source 108 coupled thereto. As a result, metal (e.g., silver in the instant example) is deposited onto self-metallized polyimide film cathode 104. The amount of silver deposited onto cathode 104 is proportional to the number of coulombs associated with the applied current over the process time. Silver foil anode 106 acts to replenish the spent silver from electroplating solution 102. In the illustrated example, a 1 milliamp constant current was applied for 3030 seconds. Prior to electroplating, self-metallized polyimide film cathode 104 weighed approximately 15.8 mg. After electroplating, cathode 104 with silver plated thereon weighed approximately 18.3 mg with the thickness of the (self-metallized) palladium and (electroplated) silver being approximately 12,000 Å. The thickness and electrical properties associated with the (i) palladium self-metallized polyimide film cathode 104 (prior to electroplating), and (ii) silver electroplated, palladium self-metallized polyimide film (after electroplating) are summarized below as follows:

| | | Sheet | Volume |
|---|---|---|---|
| | Thickness | Resistance | Resistivity |
| Material | (Å) | (ohm) | (μohm-cm) |
| Palladium self-metallized | 800 | 9.648 | 80 |
| polyimide film | | | |
| Silver-plated palladium | 12,000 | 0.044 | 5.3 |
| self-metallized polyimide film | | | |

The advantages of the present invention are numerous. As is clearly evident, the resulting thin metal film system of the present invention greatly increases electrical conductivity when compared with conventional self-metallized thin metal films. By using the metal surface of a conventional self-metallized film as a strike layer for electro or electroless metal deposition, the present invention provides a thin metal film system that is flexible, provides good adhesion between the metal and polymer without any pre-treatment of the polymer, and provides improved conductivity by being able to be fabricated at thicknesses greater than the mean free path of the metal's electron.

The present invention can be made using a variety of self-metallized polymeric films. Referring again to FIG. 1, metal surface layer 12B of self-metallized polymeric film 12 as well as the metal layer 14 can be selected from the group of metals to include palladium, platinum, gold, silver, nickel, copper, tantalum, tin, lead, mercury. Alloys of these metals could also be used. Furthermore, as is evidenced from the illustrated example, the metal for surface layer 12B need not be the same as metal layer 14.

Although the invention has been described relative to a specific embodiment thereof, there are numerous variations and modifications that will be readily apparent to those skilled in the art in light of the above teachings. For example, after metal layer 14 is deposited directly onto surface layer 12B, additional post-processing steps such as annealing might further decrease the volume resistivity of the thin metal film system. It is therefore to be understood that, within the scope of the appended claims, the invention may be practiced other than as specifically described.

What is claimed as new and desired to be secured by Letters Patent of the United States is:

1. A method of making a flexible thin metal film system, comprising the steps of:
providing a self-metallized polymeric film having a metal surface; and
depositing an electrically-conductive metal directly onto said metal surface.

2. A method according to claim 7 wherein said step of depositing comprises the step of electroplating.

3. A method according to claim 7 wherein said step of depositing comprises the step of electroless plating.

4. A method according to claim 7 wherein said metal surface comprises a metal selected from the group consisting of palladium, platinum, gold, silver, nickel, copper, tantalum, tin, lead, mercury, and alloys thereof.

5. A method according to claim 7 wherein said electrically-conductive metal is selected from the group consisting of palladium, platinum, gold, silver, nickel, copper, tantalum, tin, lead, mercury, and alloys thereof.

6. A method of making a flexible thin metal film system, comprising the steps of:
providing a strike layer defined by a metal surface of a self-metallized polymeric film; and
depositing an electrically-conductive metal directly onto said strike layer.

7. A method according to claim 12 wherein said step of depositing comprises the step of electroplating.

8. A method according to claim 12 wherein said step of depositing comprises the step of electroless plating.

9. A method according to claim 12 wherein said metal surface comprises a metal selected from the group consisting of palladium, platinum, gold, silver, nickel, copper, tantalum, tin, lead, mercury, and alloys thereof.

10. A method according to claim 12 wherein said electrically-conductive metal is selected from the group consisting of palladium, platinum, gold, silver, nickel, copper, tantalum, tin, lead, mercury, and alloys thereof.

11. A method of making a flexible thin metal film system, comprising the steps of:
fabricating a self-metallized polymeric film having a metal surface using single-stage processing; and
depositing at least one layer of an electrically-conductive metal directly onto said metal surface.

12. A method according to claim 17 wherein said step of depositing comprises the step of electroplating.

13. A method according to claim 17 wherein said step of depositing comprises the step of electroless plating.

14. A method according to claim 17 wherein said metal surface comprises a metal selected from the group consisting of palladium, platinum, gold, silver, nickel, copper, tantalum, tin, lead, mercury, and alloys thereof.

15. A method according to claim 17 wherein each said layer is selected from the group consisting of palladium, platinum, gold, silver, nickel, copper, tantalum, tin, lead, mercury, and alloys thereof.
